(19) United States
(12) Patent Application Publication
(10) Pub. No.: US 2014/0375602 A1
(43) Pub. Date: Dec. 25, 2014

(54) TACTILE PRESENTATION APPARATUS AND TACTILE PRESENTATION METHOD

(71) Applicant: Panasonic Corporation, Osaka (JP)

(72) Inventor: Kenji FUJIUNE, Osaka (JP)

(21) Appl. No.: 14/310,136

(22) Filed: Jun. 20, 2014

(30) Foreign Application Priority Data
Jun. 24, 2013 (JP) 2013-131812

(51) Int. Cl. G06F 3/044

(52) U.S. Cl. CPC G06F 3/044
USPC 345/174

(57) ABSTRACT

An apparatus according to an embodiment includes: a plurality of vibrating sections configured to cause vibration in a touch section to receive a touch made by a user; a first determination section configured to determine a plurality of vibration points on the touch section; a second determination section configured to determine a plurality of target vibrations, respectively, at the plurality of vibration points; and signal generation sections configured to generate a plurality of driving signals for respectively driving the vibrating sections, based on vibration transfer characteristic profiles obtained according to the positions of the plurality of vibration points and main component frequencies of the plurality of target vibrations, and on the plurality of target vibrations. The signal generation sections generate the plurality of driving signals based on a plurality of transfer characteristic profiles respectively corresponding to the plurality of target vibrations near the main component frequencies.

### BACKGROUND

1. Technical Field

The present disclosure relates to a tactile presentation apparatus and a tactile presentation method for presenting a tactile sensation in response to an operation made by a user.

2. Description of the Related Art

Terminals for public use that are equipped with touch panels have existed (e.g., ATMs and automatic ticket vending machines). There is also an increasing number of personal devices which are equipped with touch panels (e.g., tablet PCs and smartphones).

A touch panel is an input device which detects a touch on a panel as an input. Generally speaking, a touch panel includes a liquid crystal display, an organic EL display, or the like, in which case the touch panel is also referred to as a touch display or a touch screen. For example, a touch panel detects a touch which a user makes on a GUI object (e.g., a button) which is displayed in the display region.

A user interface in which such a touch panel is used advantageously provides high flexibility in terms of placement of GUI objects. However, a touch panel-based user interface provides less sensory feedback for a button pressing than do conventional user interfaces in which mechanical buttons are used. This presents a problem in that, when a user touches on a touch panel, the user has difficulty in knowing whether the touch has been correctly detected or not. In order to solve this problem, Published US Patent Application 2009/0250267 (hereinafter “Patent Document 1”) proposes a method of presenting a tactile sensation (haptic sensation) in response to a touch on a touch panel.

### SUMMARY

The present disclosure provides a tactile presentation apparatus and a tactile presentation method for presenting a tactile sensation in response to multiple touches.

An apparatus according to an embodiment of the present disclosure includes: a touch section configured to receive a touch made by a user; a plurality of vibrating sections configured to cause vibration in the touch section; a first determination section configured to determine a plurality of vibration points on the touch section; a second determination section configured to determine a plurality of target vibrations, respectively, at the plurality of vibration points; and a signal generation section configured to generate a plurality of driving signals for respectively driving the plurality of vibrating sections, based on vibration transfer characteristic profiles obtained according to positions of the plurality of vibration points and main component frequencies of the plurality of target vibrations, and on the plurality of target vibrations, wherein, the signal generation section generates the plurality of driving signals based on a plurality of transfer characteristic profiles respectively corresponding to the plurality of target vibrations near the main component frequencies.

With a tactile presentation apparatus according to an embodiment of the present disclosure, driving signals for driving vibrating sections are generated based on transfer characteristic profiles corresponding to target vibrations near the main component frequency thereof. Since this reduces the amount of computation for generating driving signals for the vibrating sections, response time can be reduced, and presentation of tactile sensations can be realized with little circuit and software resource.

These general and specific aspects may be implemented using a system, a method, and a computer program, and any combination of systems, methods, and computer programs.

Additional benefits and advantages of the disclosed embodiments will be apparent from the specification and Figures. The benefits and/or advantages may be individually provided by the various embodiments and features of the specification and drawings disclosure, and need not all be provided in order to obtain one or more of the same.

### BRIEF DESCRIPTION OF THE DRAWINGS

FIG. 1 is a diagram showing an example of functional blocks of a tactile presentation apparatus according to an embodiment.

FIG. 2 is a diagram showing examples of vibration points as determined by a vibration point determination section according to an embodiment.

FIG. 3 is a diagram showing examples of candidate points for vibration points corresponding to transfer characteristic profiles which are retained in a transfer characteristics storage section according to an embodiment.

FIG. 4 is a diagram showing exemplary transfer characteristic profiles of vibration points retained in a transfer characteristics storage section according to an embodiment.

FIG. 5 is a diagram showing exemplary transfer characteristic profiles of determined vibration points, as selected by a transfer characteristics acquisition section according to an embodiment.

FIG. 6 is a diagram showing exemplary transfer characteristic profiles of determined vibration points, as acquired by a transfer characteristics acquisition section according to an embodiment.

FIG. 7 includes: portion (a) which is a diagram showing an exemplary reference carrier signal waveform generated by a carrier generation section according to an embodiment; portion (b) which is a diagram showing an exemplary carrier signal waveform for a piezoelectric element generated by the carrier generation section according to an embodiment; and portion (c) which is a diagram showing an exemplary carrier signal waveform for another piezoelectric element generated by the carrier generation section according to an embodiment.

FIG. 8 includes: portion (a) which is a diagram showing an exemplary envelope signal waveform generated by a target vibration determination section according to an embodiment; portion (b) which is a diagram showing an exemplary driving signal waveform for a piezoelectric element generated by a driving multiplication section according to an embodiment; and portion (c) which is a diagram showing an exemplary driving signal waveform for another piezoelectric element generated by the driving multiplication section according to an embodiment.

FIG. 9 is a diagram showing a residual vibration estimation section according to an embodiment.

FIG. 10 includes: portion (a) which is a diagram showing an exemplary envelope signal waveform generated by a target vibration determination section according to an embodiment; portion (b) which is a diagram showing an exemplary driving signal waveform for a piezoelectric element generated by a driving multiplication section according to an embodiment; and portion (c) which is an exemplary driving signal waveform for another piezoelectric element generated by the driving multiplication section according to an embodiment.

FIG. 11 includes: portions (a) and (b) each of which is a diagram showing an exemplary driving signal waveform generated by a residual vibration estimation section according to an embodiment.

FIGS. 12A, 12B and 12C are diagrams each showing an exemplary vibration waveform of a vibration panel according to an embodiment.

FIG. 13 is a diagram showing a relationship between a gradient at the beginning and the end of an envelope signal and vibration of a vibration point which is targeted at no vibration according to an embodiment.

FIGS. 14A and 14B are diagrams each showing FFT characteristics of a target vibration of a vibration point to be vibrated according to an embodiment.

FIG. 15 is a diagram showing a relationship between a gradient at the beginning and the end of an envelope signal and a proportion of an FFT maximum value relative to an FFT area of a target vibration according to an embodiment.

FIG. 16 is a diagram showing another example of functional blocks of a tactile presentation apparatus according to an embodiment.

FIG. 17 is an example flowchart showing a procedure of vibration output according to an embodiment.

FIG. 18 includes: portion (a) which is a diagram showing an exemplary vibration waveform at a vibration point in the case where the vibration panel according to an embodiment has a strong resonance intensity; and portion (b) is a diagram showing an exemplary vibration waveform at a vibration point in the case where the vibration panel according to an embodiment has a weak resonance intensity.

FIG. 19 is a diagram showing a vibration panel according to an embodiment having buffer members provided thereon.

FIG. 20 is a diagram showing exemplary transfer characteristic profiles at a vibration point according to an embodiment in the case of a strong resonance intensity and in the case of a weak resonance intensity.

FIG. 21 is a diagram showing an example tactile presentation apparatus according to an embodiment.

FIG. 22 is a diagram showing another example tactile presentation apparatus according to an embodiment.

### DETAILED DESCRIPTION

Embodiments will now be described in detail, referring to the drawings. Note however that unnecessarily detailed descriptions may be omitted. For example, detailed descriptions on what is well known in the art or redundant descriptions on what is substantially the same constitution may be omitted. This is to avoid lengthy description, and facilitate the understanding of those skilled in the art.

The accompanying drawings and the following description, which are provided by the present inventors so that those skilled in the art can sufficiently understand the present disclosure, are not intended to limit the scope of claims. Moreover, the constructions of the respective embodiments may be combined as necessary.

First, multiple touches are defined as follows. Multiple touches mean a plurality of touches being simultaneously made on a touch panel. In other words, multiple touches mean a plurality of touches occurring on a touch panel at a given point in time. That is, multiple touches are a plurality of touches made at a plurality of positions on a touch panel, these plural touches overlapping in time. Therefore, multiple touches include not only a plurality of touches which were simultaneously started, but also a plurality of touches which were started at different points in time but detected simultaneously at a certain point in time. Specifically, if a first touch is started and then a second touch is started while the first touch continues, the first touch and the second touch constitute multiple touches at the start of the second touch.

A multiple-touch panel can be simultaneously operated by a plurality of users. Alternatively, through an operation using a plurality of fingers, a user is able to intuitive perform enlargement, rotation, etc., of a given object. In this context, when considering a feedback via tactile sensation in response to multiple touches, it would be desirable to present distinguishable tactile sensations for the respective touches.

In the case where tactile sensations are to be simultaneously presented at two or more touched positions by only using one actuator, the same kind of tactile sensation is simultaneously presented at each touched position. Moreover, with only one actuator, it is difficult to present a tactile sensation at only one of two or more touched positions.

Accordingly, in a touch panel disclosed in Patent Document 1, an array of a plurality of actuators are placed beneath a soft surface layer, each independently made to protrude or dent in the up-down direction. By allowing the actuators which are located under touched positions to independently protrude, distinguishable tactile sensations are presented in response to multiple touches.

In the touch panel disclosed in Patent Document 1, a plurality of actuators are placed in an array beneath the surface layer, whereby different tactile sensations can be simultaneously presented at a plurality of touched positions. However, in order to be able to present a tactile sensation at any arbitrary position on the surface layer, it is necessary for the actuators to be placed in units which are equal to or less than the resolving power of the human finger (on the order of 10 mm to 20 mm). Therefore, the method of Patent Document 1 requires very many actuators.

Moreover, in order to permit direct touching on GUI objects (e.g., buttons) which are displayed on the screen, a display device such as a liquid crystal display must be disposed below the actuators. This leads to considerable hardware constraints, e.g., a multitude of actuators having to be implemented by using a transparent material.

The present disclosure provides an apparatus and method for outputting vibration with comparatively little circuit and software resource. In particular, for example, a tactile presentation apparatus and a tactile presentation method for presenting tactile sensations in response to multiple touches are provided.

### Embodiment 1

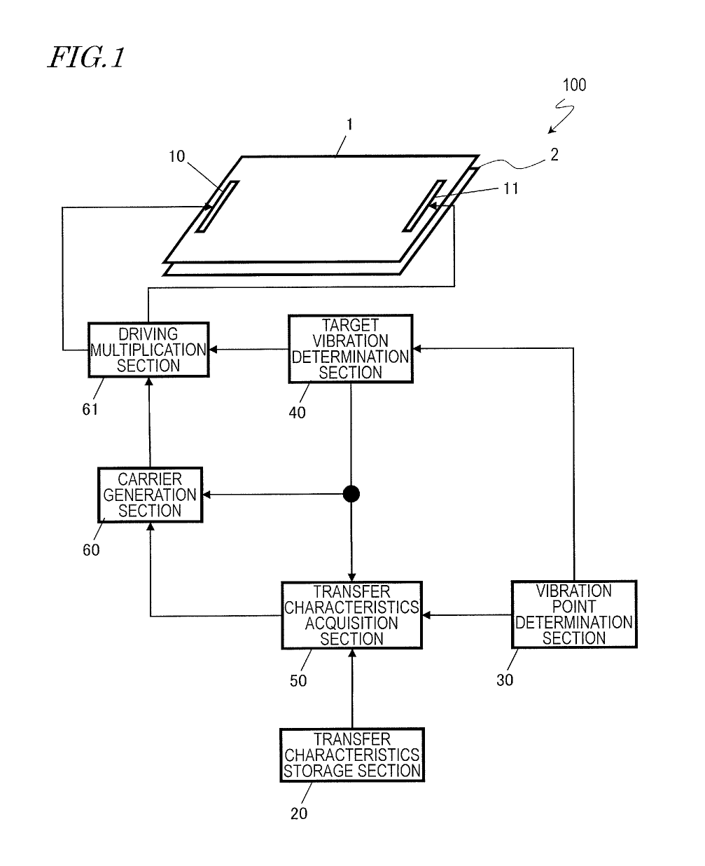

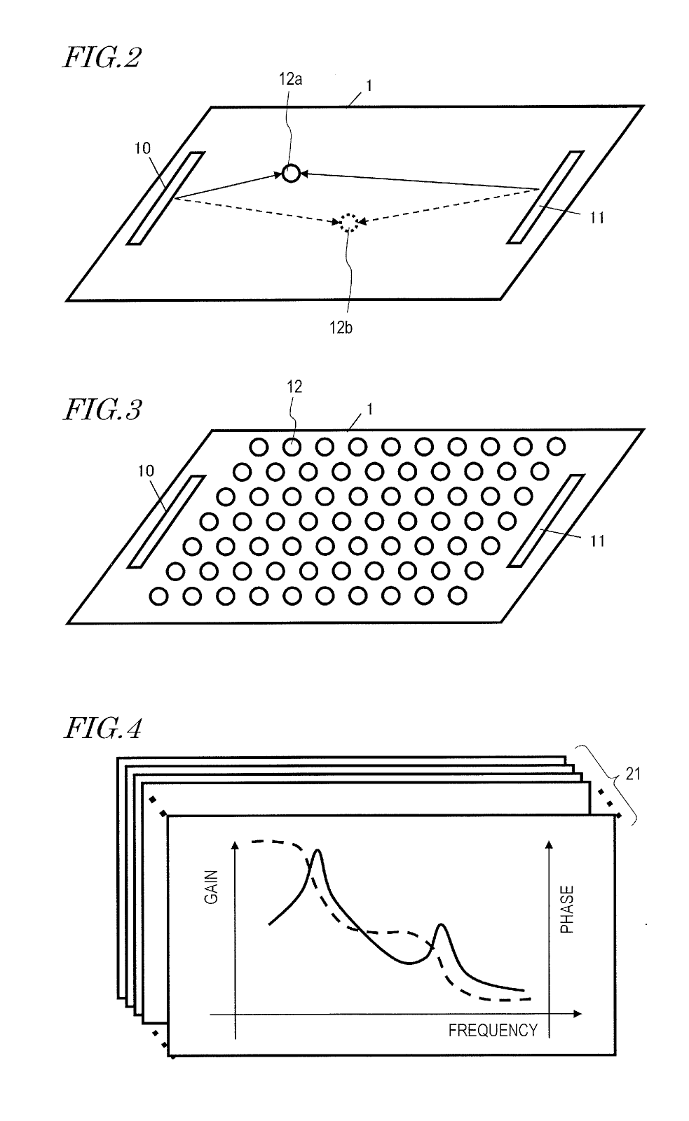

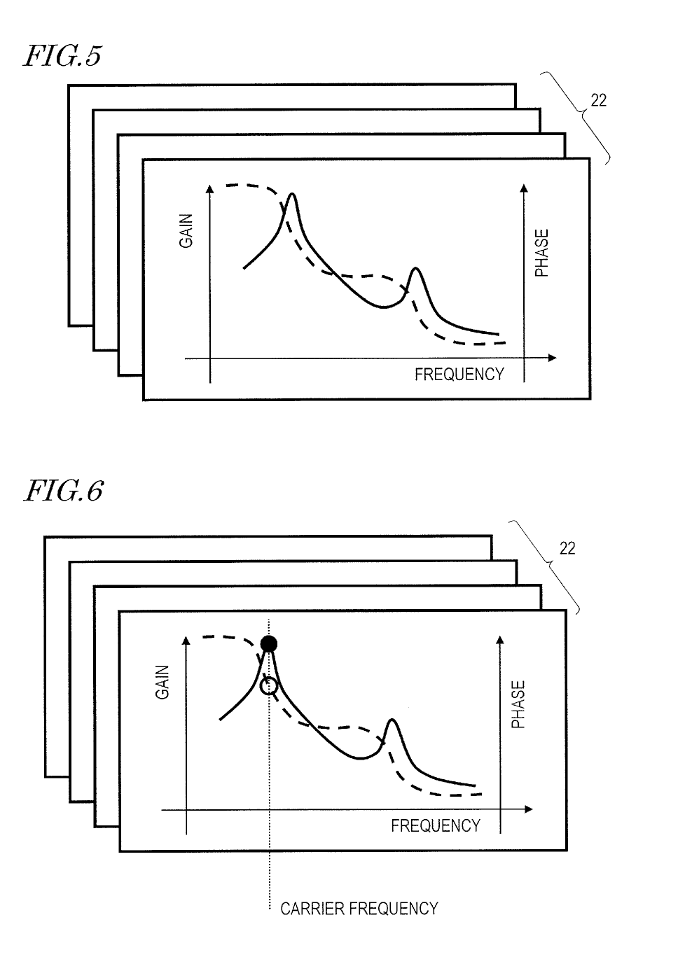

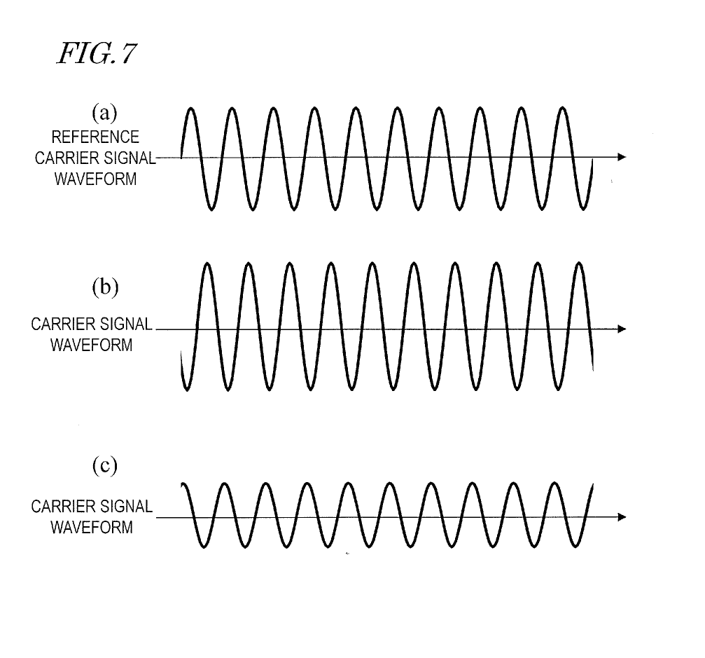

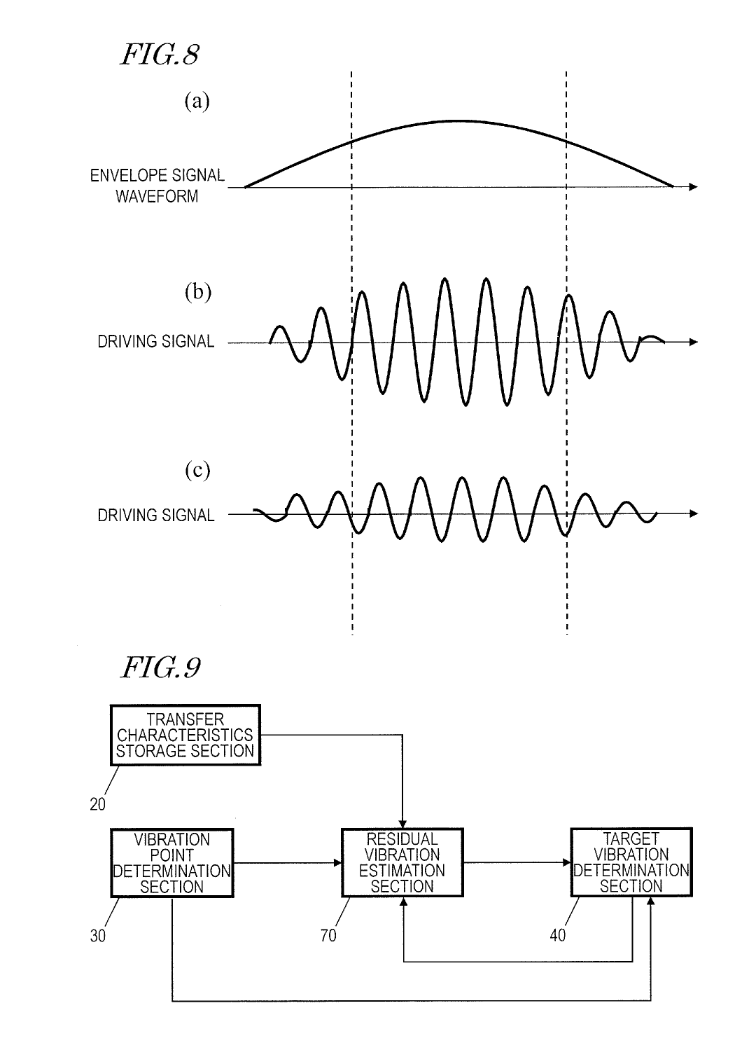

A tactile presentation apparatus according to Embodiment 1 will be described with reference to FIG. 1 to FIG. 8. FIG. 1 is a diagram showing the construction of a tactile presentation apparatus 100. FIG. 2 is a diagram showing examples of vibration points as determined by a vibration point determination section 30. FIG. 3 is a diagram showing examples of candidate points for vibration points corresponding to transfer characteristic profiles which are retained in a transfer characteristics storage section 20. FIG. 4 is a diagram showing exemplary transfer characteristic profiles retained in the transfer characteristics storage section 20. FIG. 5 is a diagram showing exemplary transfer characteristic profiles acquired by a transfer characteristics acquisition section 50. FIG. 6 is a diagram showing other exemplary transfer characteristic profiles acquired by the transfer characteristics acquisition section 50. FIG. 7(a) shows an exemplary reference carrier signal waveform generated by a carrier generation section 60. FIG. 7(b) shows an exemplary carrier signal waveform generated by the carrier generation section 60. FIG. 7(c) shows another exemplary carrier signal waveform generated by the carrier generation section 60. In FIG. 7, the horizontal axis represents time and the vertical axis represents the respective signal level. FIG. 8(a) shows an exemplary envelope signal waveform generated by a target vibration determination section 40. FIG. 8(b) shows an exemplary driving signal waveform generated by a driving multiplication section 61. FIG. 8(c) shows another exemplary driving signal waveform generated by the driving multiplication section 61. In FIG. 8, the horizontal axis represents time and the vertical axis represents the respective signal level.

The tactile presentation apparatus 100 includes a vibration panel 1 which presents tactile sensations through contact with the user and a plurality of piezoelectric elements 10 and 11 for vibrating the vibration panel 1. As shown in FIG. 3, the vibration panel 1 includes a plurality of candidates for vibration points, i.e., points to be vibrated by the piezoelectric elements.

The tactile presentation apparatus 100 further includes: a vibration point determination section 30 for determining, from among the plurality of candidate points for vibration points on the vibration panel 1, a plurality of vibration points to be actually vibrated for presenting tactile sensations; a target vibration determination section 40 for determining target vibrations to occur at the determined plural vibration points; and a carrier generation section 60 and a driving multiplication section 61 for generating driving signals for driving the piezoelectric elements 10 and 11 based on vibration transfer characteristic profiles obtained according to the positions of the determined plural vibration points and main component frequencies of the determined target vibrations, and on the determined target vibrations. Each of these sections may be designed as a dedicated hardware circuit, or a processor may execute its function in accordance with a program.

Based on the transfer characteristic profiles corresponding to near the main component frequency of the determined target vibrations, the carrier generation section 60 and the driving multiplication section 61 generate driving signals. The carrier generation section 60 and the driving multiplication section 61 function as a driving signal generation section for generating driving signals for the piezoelectric elements 10 and 11. Moreover, the tactile presentation apparatus 100 includes: the transfer characteristics storage section 20 for storing the transfer characteristic profiles of vibration from the piezoelectric elements 10 and 11 to the respective vibration points on the vibration panel 1; and a transfer characteristics acquisition section 50 which, based on the positions of the determined plural vibration points and the main component frequency of the determined target vibrations, acquires from the transfer characteristics storage section 20 the transfer characteristic profiles to be used for driving the piezoelectric elements 10 and 11. The transfer characteristics acquisition section 50 acquires the transfer characteristic profiles corresponding to near the main component frequency of the determined target vibrations.

Moreover, the tactile presentation apparatus 100 may include a display section 2 for displaying images of GUI objects (e.g. buttons) and the like. The display section 2 may be, for example, a liquid crystal display or an organic EL display. In the absence of need for an image to be displayed in a region that is touched by the user (e.g., as when the tactile presentation apparatus 100 is used as a touch pad), the display section 2 can be omitted.

The vibration panel 1 is a member which propagates vibration for presenting tactile sensations. Specifically, the vibration panel 1 is a plate-like light-transmitting member of glass or acrylic resin, for example. The piezoelectric elements 10 and 11 are placed at different positions on the vibration panel 1. For example, as shown in FIG. 1, the piezoelectric elements 10 and 11 are attached at the right and left ends of the vibration panel 1. For example, the piezoelectric elements 10 and 11 are placed at positions which are distanced on the vibration panel 1, such that a line connecting the positions passes through the center of the vibration panel 1. This is to allow more accurate and perceivable tactile sensations to be presented near the center, since the central portion and the like is more likely to be touched by the user than the ends of the vibration panel 1. The piezoelectric elements 10 and 11 vibrate the vibration panel 1 in accordance with driving signals. As the vibration which is applied to the vibration panel 1 by the piezoelectric elements 10 and 11 propagates, a tactile sensation is presented to the user. The number of piezoelectric elements is equal to or greater than the number of points at which to control vibration. The present embodiment illustrates an example where two vibration points are to be determined and vibration is to be controlled at the two determined vibration points; therefore, two piezoelectric elements are used.

The vibration panel 1, which is a capacitance type or pressure-sensitive type touch panel, for example, accepts a touch operation by the user and detects the touched position(s). The method of detecting touched positions is not limited to the capacitance type or the pressure-sensitive type, and any method may be used that allows multiple touches to be detected. Furthermore, in the case where the tactile presentation apparatus 100 is installed on a wall or a pillar at a store, a train station, etc., constructions other than touch detection by the vibration panel 1 may be adopted: for example, video information that is acquired by an installed camera which is directed toward the vibration panel 1 may be analyzed to determine whether there has been a touch or not.

Although the vibration panel 1 of a planar shape is illustrated as an example, the shape of the vibration panel 1 is not limited thereto. For example, the vibration panel 1 may be curved, or may be cylindrical or the like. Such different shapes will cause the appropriate number and positions of piezoelectric elements to differ; however, the points, areas, etc., that are most likely to be touched by the user may be designed in view of the use case and the shape.

The vibration point determination section 30 determines two vibration points, i.e., positions at which to control vibration on the vibration panel 1, and sends them to the transfer characteristics acquisition section 50. On the vibration panel 1, a plurality of candidate points are allocated as prospective vibration points. For example, as indicated by white circles in FIG. 3, there are 70 candidate points 12 for vibration points. The vibration point determination section 30 selects those vibration points which are at or near positions that match the touched positions which have been detected by the vibration panel 1, from among predetermined vibration points, vibration points which are prescribed for each application that is being executed on the tactile presentation apparatus 100, or the 70 candidate points 12, for example.

The target vibration determination section 40 determines target vibrations to be generated at the two vibration points on the vibration panel 1 that have been selected by the vibration point determination section 30. A target vibration is expressed in terms of information of an envelope signal and a carrier frequency of the vibration. The envelope signal is sent to the driving multiplication section 61, and the carrier frequency is sent to the transfer characteristics acquisition section 50 and the carrier generation section 60. The envelope signal is a curve that is manifested by the peaks of a waveform, and may have a waveform as shown in FIG. 8(a), for example. The carrier frequency is a frequency that determines the modulation period.

For each candidate point on the vibration panel 1, the transfer characteristics storage section 20 stores transfer characteristic profiles from the respective piezoelectric elements to that point. The transfer characteristics acquisition section 50 acquires transfer characteristic profiles for each determined vibration point from the transfer characteristics storage section 20. A transfer characteristic profile indicates a relationship between the input and the output of a system. In the present embodiment, a driving signal for one piezoelectric element is the input, whereas the vibration at one of the candidate points for vibration points on the vibration panel 1 is the output. A transfer characteristic profile can be expressed in terms of a gain and a phase at each frequency.

From among the plurality of transfer characteristic profiles stored in the transfer characteristics storage section 20, the transfer characteristics acquisition section 50 acquires transfer characteristic profiles based on the positions of the two vibration points determined by the vibration point determination section 30 and a carrier frequency from the target vibration determination section 40, and sends them to the carrier generation section 60.

Based on the carrier frequency from the target vibration determination section 40 and the transfer characteristic profiles from the transfer characteristics acquisition section 50, or specifically four gains and four phases, the carrier generation section 60 generates carrier signals to be used for the driving signals for the piezoelectric elements 10 and 11, and sends them to the driving multiplication section 61.

The driving multiplication section 61 multiplies an envelope signal from the target vibration determination section 40 by two carrier signals from the carrier generation section 60 corresponding to the piezoelectric elements 10 and 11 to generate two driving signals, which are respectively sent to the piezoelectric elements 10 and 11.

From among candidate points for vibration points corresponding to the transfer characteristic profiles that are stored in the transfer characteristics storage section 20, the vibration point determination section 30 determines a white circle in solid line shown in FIG. 2 as a first vibration point 12a and a white circle in broken line as a second vibration point 12b, for example.

For instance, as a target vibration at the first vibration point 12a, the target vibration determination section 40 determines a vibration which has an envelope signal of a half wave of a sine wave shape as shown in FIG. 8(a) and a carrier signal of a sine wave shape with a resonant frequency of the vibration panel 1. For instance, the target vibration determination section 40 determines “no vibration” as the target vibration at the second vibration point 12b.

The transfer characteristics storage section 20 stores transfer characteristic profiles in association with combinations of the candidate points for vibration points on the vibration panel 1 and the piezoelectric elements. When there are 70 candidate points for vibration points (FIG. 3) and two piezoelectric elements, there are 140 transfer characteristic profiles. From among the 140 transfer characteristic profiles 21 stored in the transfer characteristics storage section 20 as illustrated in FIG. 4, the transfer characteristics acquisition section 50 selects four transfer characteristic profiles 22 corresponding to two vibration points and two piezoelectric elements as illustrated in FIG. 5. Furthermore, based on the selected transfer characteristic profiles 22 and the carrier frequency (main component of the target vibration) from the target vibration determination section 40, the transfer characteristics acquisition section 50 acquires each transfer characteristic profile at or near the carrier frequency. Thus, the transfer characteristics acquisition section 50 acquires only transfer characteristic profiles at the carrier frequency from the target vibration determination section 40. In other words, for example, as illustrated in FIG. 6, four gains indicated by black circles and four phases indicated by white circles are acquired from the four transfer characteristic profiles, while the transfer characteristic profiles at any other frequency are not acquired. This allows desired tactile sensations to be presented through a small amount of processing. This construction provides an excellent effect of implementation through little hardware and/or software.

The carrier generation section 60 derives an inverse matrix of a transfer matrix G of transfer characteristic profiles (gain, phase) acquired by the transfer characteristics acquisition section 50, each representing propagation from a driving signal to a piezoelectric element to vibration at a vibration point on the vibration panel 1. The inverse matrix represents transfer characteristic profiles of vibration at the respective vibration points on the vibration panel 1 back to a driving signal for each piezoelectric element. By multiplying the derived inverse matrix and a matrix D representing states of vibration, a filter matrix H is calculated. The details of the calculation for calculating such a filter matrix are described in the pamphlet of International Publication No. 13/161163. The disclosure of the pamphlet of International Publication No. 13/161163 is incorporated herein by reference.

For example, a matrix D representing states of vibration is expressed as indicated in eq. (1), by using the transfer matrix G and the filter matrix H. N denotes the number of vibration points, which in the present embodiment is 2. M denotes the number of piezoelectric elements, which in the present embodiment is 2.

$$D = GH \\ D = [ \begin{matrix}{D}_{1} ( ω ) \\ {D}_{2} ( ω ) \\ ⋮ \\ {D}_{N} ( ω )\end{matrix} ] \\ G = [ \begin{matrix}{G}_{11} ( ω ) & {G}_{12} ( ω ) & … & {G}_{1 M} ( ω ) \\ {G}_{21} ( ω ) & {G}_{22} ( ω ) & … & {G}_{2 M} ( ω ) \\ ⋮ & ⋮ & ⋱ & ⋮ \\ {G}_{N 1} ( ω ) & {G}_{N 2} ( ω ) & … & {G}_{NM} ( ω )\end{matrix} ] \\ H = [ \begin{matrix}{H}_{1} ( ω ) \\ {H}_{2} ( ω ) \\ ⋮ \\ {H}_{M} ( ω )\end{matrix} ] \qquad eq . ( 1 )$$

In eq. (1), a transfer characteristic profile Gᵢⱼ(Ω) is a transfer characteristic profile from a piezoelectric element Aⱼ to a vibration point Pᵢ. A filter matrix Hⱼ(Ω) is a filter for generating a driving signal for the piezoelectric element Aⱼ. A matrix Dᵢ(Ω) represents a state of vibration and is a response at the vibration point Pᵢ. Now, in the frequency band for controlling, a desired filter can be obtained by calculating a filter matrix H such that vibration occurs at the first vibration point 12a to result in (D₁(Ω)=1) and that no vibration occurs at the second vibration point 12b to result in (D₂(Ω)=0).

Although the aforementioned exemplary filter calculation method is not a limitation, calculating a general inverse matrix G* of G allows the filter matrix to be calculated from the general inverse matrix G* of G and the matrix D representing states of vibration, as in eq. (2).

H=G*D eq. (2)

In the present embodiment, the filter matrix H is derived from two transfer characteristic profiles corresponding to the respective piezoelectric elements. Since the frequency of the transfer matrix G is only one carrier frequency, the frequency of the filter matrix H is also only one carrier frequency. In other words, the filter matrix H is determined based on transfer characteristic profiles (carrier gain, carrier phase) for a driving signal for the piezoelectric element 11 and transfer characteristic profiles (carrier gain, carrier phase) for a driving signal for the piezoelectric element 10, at the carrier frequency. For example, the carrier generation section 60 first generates a reference carrier signal having a carrier frequency as shown in FIG. 7(a). Then, as shown in FIG. 7(b) and FIG. 7(c), the carrier generation section 60 multiplies the reference carrier signal with a carrier gain corresponding to each piezoelectric element, thus generating carrier signals whose phases are shifted by the carrier phase.

The driving multiplication section 61 multiplies an envelope signal as shown in FIG. 8(a) by the carrier signal shown in FIG. 7(b) to generate a driving signal for the piezoelectric element 10 as shown in FIG. 8(b). Moreover, the driving multiplication section 61 multiplies an envelope signal as shown in FIG. 8(a) by the carrier signal shown in FIG. 7(c) to generate a driving signal for the piezoelectric element 11 as shown in FIG. 8(c).

Thus, in a calculation of driving signals for providing the user with tactile sensations via independent vibrations at a plurality of vibration points, using limited transfer characteristic profiles for the driving signal calculation, i.e., those pertaining only to the carrier frequency, allows to reduce the amount of computation and the response time, and also is compatible with little circuit and software resource.

Although the present embodiment illustrates that the vibration point determination section 30 determines the vibration points from among candidate points that are stored in the transfer characteristics storage section 20, the vibration points may be determined based on touched positions at which the user has touched the vibration panel 1. In this case, sensor outputs are supplied as inputs to the vibration point determination section 30. If there are two detected touched positions, candidate points which are located on or near the two are selected as vibration points. If it seems that two or more touched positions are detected, they may be narrowed down to the two which are highly likely to have been meant to be touched by the user, by relying on differences among sensor output levels, etc. Alternatively, the candidate points that are the closest to the touched positions may be determined as the vibration points.

Although the present embodiment illustrates use of two vibration points, three or more vibration points may instead be used.

Although the present embodiment illustrates that the candidate points for vibration points are in a rectangular arrangement, arrangements in other shapes may also be adopted. Moreover, the interval between candidate points for vibration points does not need to be constant. The intervals between candidate points for vibration points may be varied: for example, the interval may be decreased near the center of the vibration panel 1, where touches will presumably occur more frequently, and increased toward the ends. Note that the smaller the interval between candidate points for vibration points is, the better the tactile presentation resolution will be, but the greater storage capacity will be needed for storing the transfer characteristic profiles. That is, resolution and storage capacity are at a tradeoff; the interval between candidate points for vibration points may be determined based on the resolution needed, tolerable storage capacity, and so on.

Although the present embodiment illustrates that the vibration panel 1 is rectangular, there is no particular limitation as to the shape, size, thickness, hardness, method of fixing, and so on of the vibration panel 1. However, depending on the shape, size, thickness, hardness, method of fixing, and so on of the vibration panel 1, the transfer characteristic profiles from the piezoelectric elements to vibration points on the vibration panel 1 will vary.

Although two piezoelectric elements are utilized in the present embodiment, three or more piezoelectric elements may be utilized.

Although the present embodiment illustrates that vibration of the vibration panel 1 is generated by using piezoelectric elements, there is no particular limitation as to the vibration source. Vibration motors or the like may be used.

Although Embodiment 1 illustrates that the piezoelectric elements are placed at the right and left ends of the vibration panel 1, there is no particular limitation as to the placement of the piezoelectric elements. The piezoelectric elements may be disposed anywhere so long as they are far enough apart to allow a plurality of vibration points to exist in an area of the vibration panel 1 where tactile sensations are to be presented.

Although Embodiment 1 illustrates that driving signals for the piezoelectric elements are calculated by using transfer characteristic profiles pertaining only to the carrier frequency, driving signals for the piezoelectric elements may be calculated by using transfer characteristic profiles at a plurality of frequencies including the carrier frequency.

Embodiment 1 illustrates that a vibration is generated at the first vibration point and no vibration is generated at the second vibration point. However, other driving signals for causing a vibration to occur at the second vibration point and no vibration to occur at the first vibration point may be separately calculated and added, thus allowing independent vibrations to occur at the first vibration point and at the second vibration point.

Although Embodiment 1 illustrates that the transfer characteristic profiles stored in the transfer characteristics storage section 20 are expressed in the frequency domain, they may be stored as transfer characteristic profiles expressed in the time domain. Transfer characteristic profiles which are expressed in the time domain and those expressed in the frequency domain are equivalent information, and are mutually convertible.

Although the transfer characteristic profiles are expressed in terms of gain and phase in Embodiment 1, they may be expressed in terms of complex-number gain.

Although Embodiment 1 illustrates that the transfer characteristic profiles stored in the transfer characteristics storage section 20 are transfer characteristic profiles spanning a certain range of frequencies, only the transfer characteristic profiles at the frequency that is used as the carrier frequency may be stored.

Although Embodiment 1 illustrates that the carrier frequency is the resonant frequency of the vibration panel 1, any frequency may be used so long as tactile sensations can be presented to the user.

Embodiment 1 illustrates that driving signals for the piezoelectric elements are derived in such a manner that, after carrier signals corresponding to the respective piezoelectric elements are generated, they are multiplied by a common envelope. However, there is no limitation as to the order of calculations, and separate envelopes corresponding to the respective piezoelectric elements may be generated.

Note that these generic or specific implementations may be implemented in the form of a system, a method, an integrated circuit, a computer program, or a storage medium, or in a combination of any of a system, a method, an integrated circuit, a computer program, and a storage medium.

### Embodiment 2

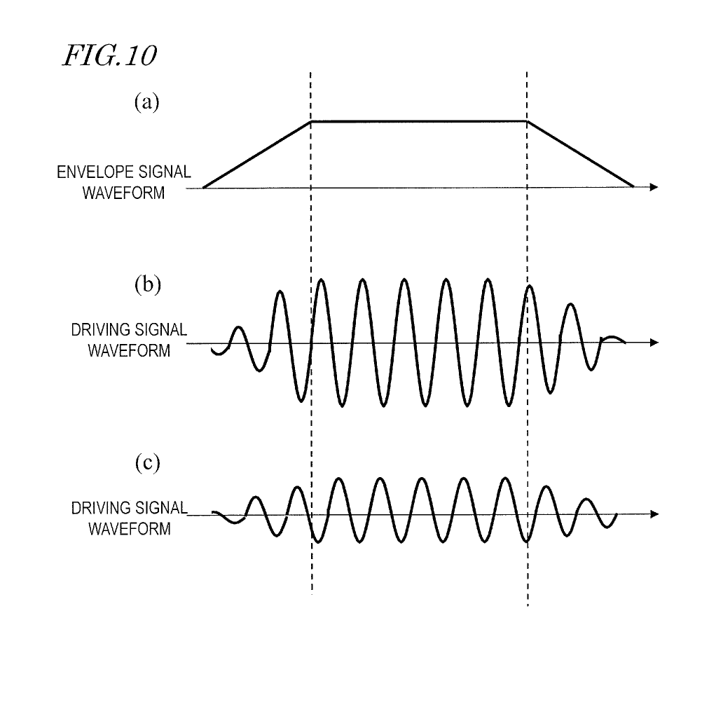

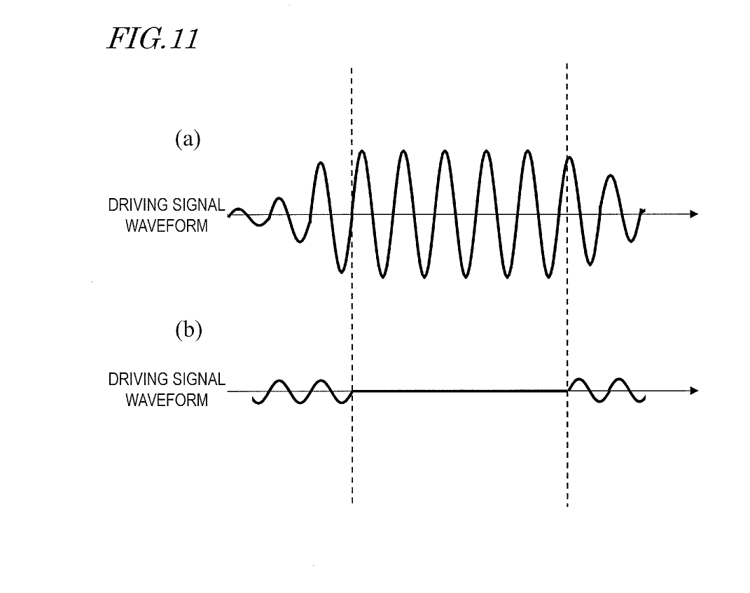

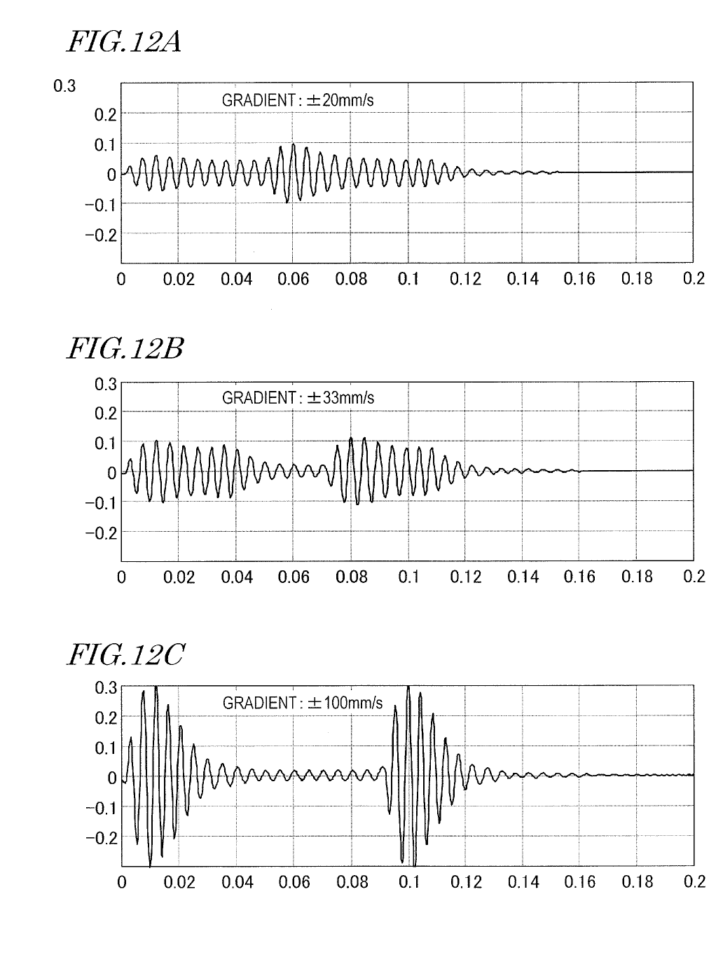

An tactile presentation apparatus 100 according to Embodiment 2 will be described with reference to FIG. 9 through FIG. 12A to 12C. FIG. 9 is a diagram for describing a residual vibration estimation section 70, which marks a difference in construction between the present embodiment and Embodiment 1. FIG. 10(a) shows an exemplary envelope signal waveform generated by the target vibration determination section 40. FIG. 10(b) shows an exemplary driving signal waveform generated by the driving multiplication section 61. FIG. 10(c) shows an exemplary driving signal waveform generated by the driving multiplication section 61. In FIG. 10, the horizontal axis represents time, and the vertical axis represents the respective signal level. FIG. 11(a) and FIG. 11(b) show exemplary driving signal waveforms generated by the residual vibration estimation section 70. In FIG. 11, the horizontal axis represents time, and the vertical axis represents the respective signal level. FIGS. 12A to 12C represent exemplary vibration waveforms of the vibration panel 1. In FIG. 12A to 12C, the horizontal axis represents time, and the vertical axis represents the respective signal level.

The construction of FIG. 9 is added to the tactile presentation apparatus 100 of FIG. 1. As for FIG. 9, only differences from FIG. 1 will be described, while omitting any redundant description. The transfer characteristics storage section 20 stores transfer characteristic profiles, and sends them to the residual vibration estimation section 70. The vibration point determination section 30 determines the positions of two vibration points, and sends them to the residual vibration estimation section 70. Based on the transfer characteristic profiles from the transfer characteristics storage section 20, the positions of the two vibration points from the vibration point determination section 30, and an envelope signal and a carrier frequency from the target vibration determination section 40, the residual vibration estimation section 70 estimates residual vibrations, and sends them to the target vibration determination section 40. Based on the residual vibrations from the residual vibration estimation section 70, the target vibration determination section 40 adjusts a gradient of the envelope signal, and sends the envelope signal and the carrier frequency to the residual vibration estimation section 70. Although the residual vibration estimation section 70 is illustrated as acquiring the transfer characteristic profiles from the transfer characteristics storage section 20, the transfer characteristics acquisition section 50 may be replaced by the residual vibration estimation section 70 in this case. In the other case where both the transfer characteristics acquisition section 50 and the residual vibration estimation section 70 are provided, the residual vibration estimation section 70 may not be connected to the transfer characteristics storage section 20, and the transfer characteristic profiles may be acquired from the transfer characteristics acquisition section 50.

In the method illustrated in Embodiment 1, the amount of computation is reduced by limiting the frequency of the transfer characteristic profiles to only the carrier frequency. In the case of target vibrations which are based only on the carrier frequency, driving signals for the piezoelectric elements can be correctly generated, so that the vibration at the first vibration point can be set to a level that is perceivable to the user while the vibration at the second vibration point can be set to a level that is unperceivable to the user, for example. However, finite-length target vibrations are needed when outputting vibrations which are adapted to touch operations or the like. In a finite-length target vibration, frequency components other than those of the carrier frequency will occur at the beginning and the end of the vibration. In the method illustrated in Embodiment 1, only transfer characteristic profiles at the carrier frequency are utilized, so that driving signals for the piezoelectric elements cannot be correctly generated with respect to any frequency components other than the carrier frequency of the target vibration. Therefore, the generated vibration may have a residual vibration with respect to the target vibration. In the above example, the vibration at the first vibration point is originally at a perceive level to the user, so that, even if there is some residual vibration, the difference will hardly be recognized by the user. However, the vibration at the second vibration point was originally at an unperceivable level to the user, so that any increased vibration due to the residual vibration may be perceived by the user. Thus, occurrence of a residual vibration may make it difficult to generate independent desired vibrations at two vibration points.

Now, an example method of estimating vibration at each vibration point on the vibration panel 1 by utilizing transfer characteristic profiles will be described.

In the present embodiment, the transfer characteristics of the vibration panel 1 are regarded as a linear time invariant system. A transfer characteristic profile is expressed in terms of a gain and a phase at each frequency. In the case where a sine wave is used as a driving signal for a piezoelectric element, the vibration of the vibration panel 1 is estimated as a sine wave obtained by multiplying the driving signal by the gain at the corresponding frequency and shifting the phase.

In the case where an arbitrary signal is used as a driving signal for a piezoelectric element, the driving signal is decomposed into frequency components, and the vibration of the vibration panel 1 with respect to a sine wave of each frequency is obtained. The vibration of the vibration panel 1 is estimated as a sum total of the vibrations of the vibration panel 1 at the respective frequencies.

In the case where a plurality of piezoelectric elements are used, the vibration of the vibration panel 1 is determined for each piezoelectric element. The vibration of the entire vibration panel 1 is estimated as a sum total of the vibrations of the respective piezoelectric elements.

The transfer characteristics storage section 20 retains the transfer characteristic profiles at a plurality of candidate points for vibration points on the vibration panel 1, and, by using these transfer characteristic profiles, the residual vibration estimation section 70 estimates a vibration at each vibration point on the vibration panel 1 with respect to a driving signal for a piezoelectric element.

Although it is illustrated to be gains and phases at the respective frequencies that are retained as the transfer characteristic profiles of the vibration panel 1, instead, impulse responses may be retained as the transfer characteristic profiles of the vibration panel 1. An impulse response represents a vibration of the vibration panel 1 when a driving signal for a piezoelectric element has very short pulses. Theoretically, the vibration of the vibration panel 1 is expressed in continuous time, assuming driving signal pulses with an infinitesimal time span and an infinite height. In an actual system, however, the driving signal and the vibration of the vibration panel 1 are treated as discrete signals, and the driving signal is supposed to have “1” level at certain points in time and a “0” level at other points in time.

When the pulses of a driving signal vary in level, only the magnitude of the vibration of the vibration panel 1 varies in proportion to the level of the driving signal, without changing its shape.

The vibration of the vibration panel 1 in response to a plurality of pulses occurring at different points in time will be a sum of the vibrations of the vibration panel 1 for the respective pulses.

Furthermore, an arbitrary driving signal can be decomposed into pulses differing in level and points in time of occurrence.

Therefore, the vibration of the vibration panel 1 in the case where an arbitrary signal is used as a driving signal for a piezoelectric element is estimable as a sum total of the vibrations of the vibration panel 1 at respective plural pulses into which the driving signal is decomposed.

The target vibration determination section 40 determines, as the target vibration at the first vibration point, a vibration having a trapezoidal envelope signal as shown in FIG. 10(a) and having a sine wave-shaped carrier signal at the resonant frequency of the vibration panel 1, and determines “no vibration” as the a target vibration at the second vibration point, for example. As the envelope signal undergoes greater changes, components of the target vibration other than that of the carrier frequency will increase. In other words, as the envelope signal has a greater gradient, there will be greater residual vibration. Therefore, in the central portion of the target vibration, the envelope signal is kept flat (i.e., zero gradient), and the envelope signal may have linear slants at the beginning and the end of the target vibration, thus minimizing the gradient occurring in the envelope signal. As a result of this, the envelope signal takes a trapezoidal shape.

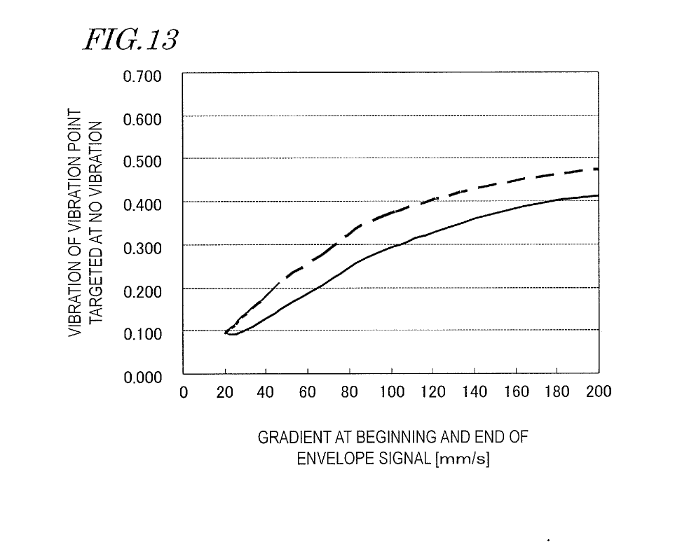

Now, the relationship between the residual vibration at a non-vibrating point and linear-envelope signal waveforms will be further described. FIG. 13 is a diagram showing a relationship between a gradient at the beginning and the end of an envelope signal and vibration of a vibration point which is targeted at no vibration. The horizontal axis represents the gradient at the beginning and the end of the envelope signal, and the vertical axis represents the level of vibration. The solid line denotes characteristics in the case where the envelope signal is trapezoidal, and the broken line denotes characteristics in the case where the envelope signal is sinusoidal.

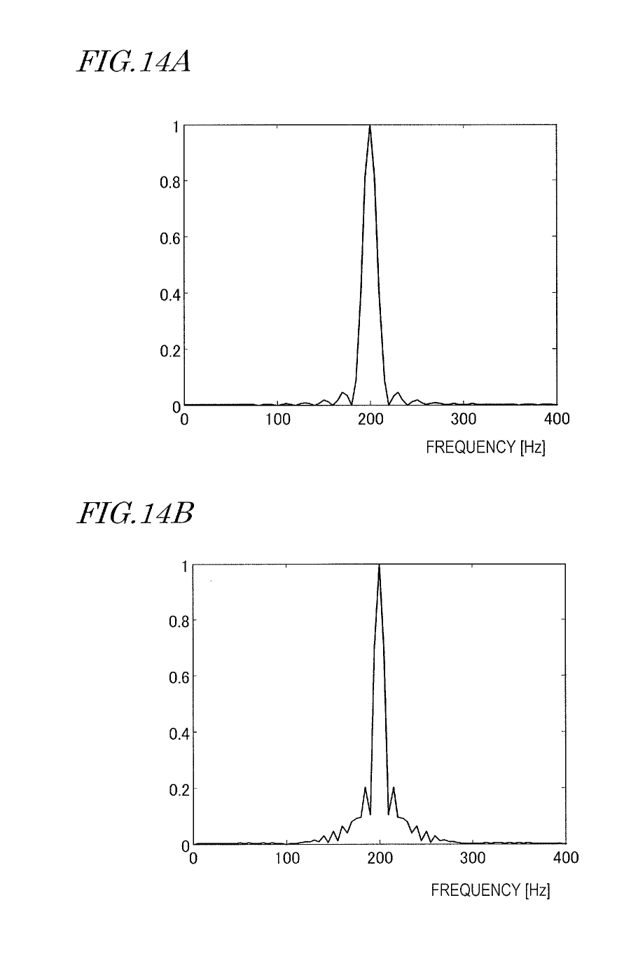

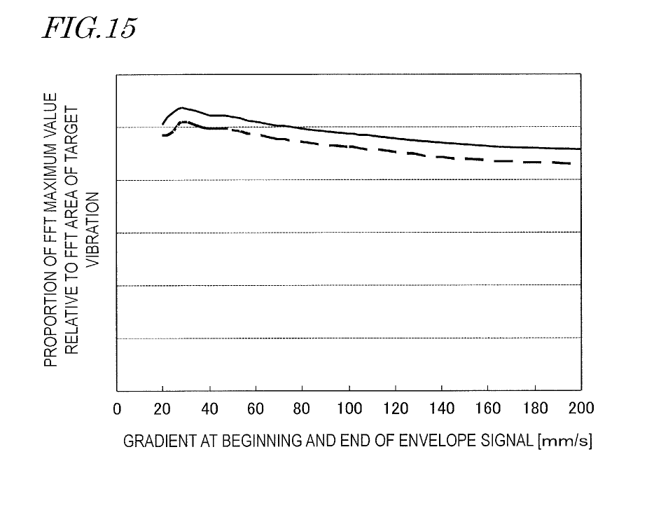

FIGS. 14A and 14B are diagrams showing FFT characteristics of the target vibration of a vibration point to be vibrated. The horizontal axis represents frequency, and the vertical axis represents the level of vibration. FIG. 14A shows FFT characteristics in the case where the gradient at the beginning and the end of the envelope signal is ±20 mm/s. FIG. 14B shows FFT characteristics in the case where the gradient at the beginning and the end of the envelope signal is ±100 mm/s. In FIGS. 14A and 14B, the envelope signal is trapezoidal.

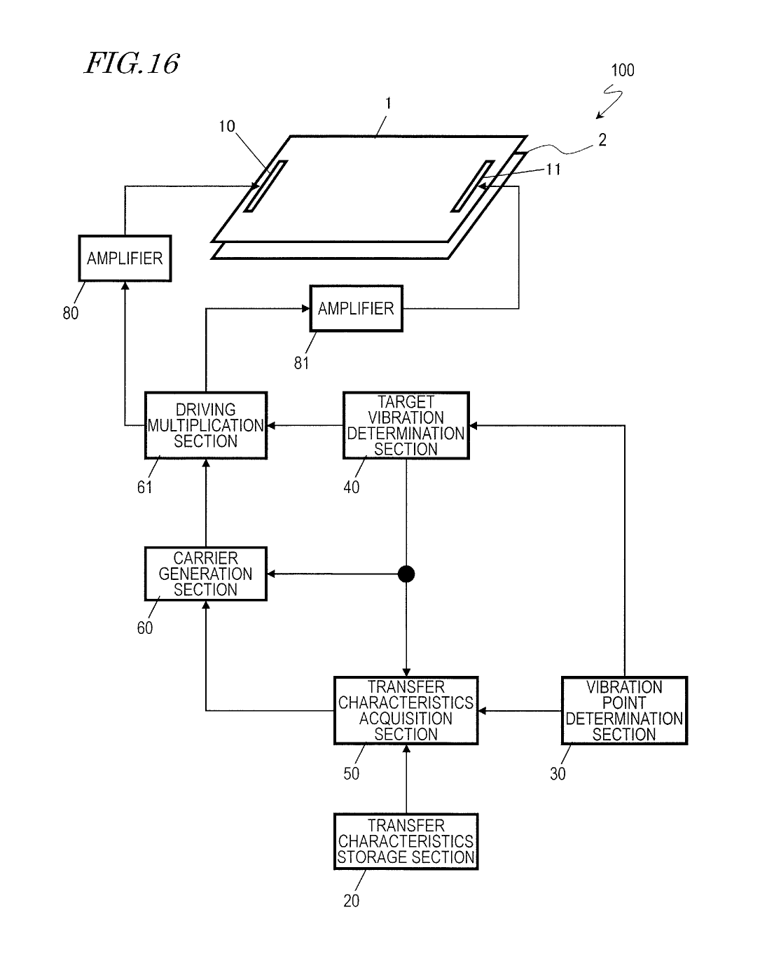

FIG. 15 is a diagram showing the relationship between the gradient at the beginning and the end of the envelope signal and the proportion of an FFT maximum value relative to an FFT area of a target vibration. The horizontal axis represents a gradient at the beginning and the end of the envelope signal. The solid line denotes characteristics in the case where the envelope signal is trapezoidal, and the broken line denotes characteristics in the case where the envelope signal is sinusoidal.

Simulation results of the magnitude of residual vibration when varying the gradient at the beginning and the end of the envelope signal are shown in FIG. 13. As shown in FIG. 13, as the gradient at the beginning and the end of the envelope signal decreases, the residual vibration decreases. It can also be seen that the residual vibration is smaller when the envelope signal is trapezoidal, as indicated by the solid line.

The reasons for such differences in characteristics will be described. When the gradient at the beginning and the end of the envelope signal increases, as shown in FIGS. 14A and 14B, components other than that of the carrier frequency will increase in the FFT characteristics of the target vibration. The calculation utilizes only the transfer characteristic profiles pertaining to the carrier frequency; therefore, as components other than that of the carrier frequency of the target vibration increase, there will be greater errors in the driving signal to be derived, thus resulting in a greater residual vibration.

As shown in FIG. 15, the proportion of the maximum value relative to the geometric area of the FFT characteristics of the target vibration is greater when the envelope signal has a linear shape (solid line) than when it is sinusoidal (broken line). That is, the carrier frequency component of the target vibration is more predominant when the envelope signal is trapezoidal than when it is sinusoidal, thus resulting in less component other than that of the carrier frequency. Therefore, there is less residual vibration when the shape of the envelope signal is trapezoidal than when it is sinusoidal.

From the transfer characteristics storage section 20 or the transfer characteristics acquisition section 50, the residual vibration estimation section 70 acquires four transfer characteristic profiles corresponding to two vibration points and two piezoelectric elements. From the four acquired transfer characteristic profiles and the two generated driving signals, vibration at two vibration points is estimated. By calculating a difference between the estimated vibration and the target vibration from the target vibration determination section 40, a residual vibration is estimated.

While varying the gradient at the beginning and the end of the envelope signal, the target vibration determination section 40 acquires a residual vibration at each gradient from the residual vibration estimation section 70. The target vibration determination section 40 determines an envelope signal that has the largest gradient while keeping the residual vibration within a tolerable range. Based on the determined envelope signal, in a manner similar to Embodiment 1, the carrier generation section 60 generates a carrier signal, and the driving multiplication section 61 generates a driving signal with which to actually vibrate the vibration panel 1.

Example vibration amounts at the second vibration point when varying the gradient at the beginning and the end of the envelope signal are shown in FIG. 12A to 12C. Since the target vibration at the second vibration point is no vibration, any vibration occurring there would be residual vibration. It is assumed that the target vibration conditions at the first vibration point are: a length of 100 ms, a carrier frequency of 200 Hz, and an amplitude of ±1 mm. It is assumed that the gradient at the beginning and the end of the envelope signal is ±20 mm/s in FIG. 12A, ±33 mm/s in FIG. 12B, and ±100 mm/s in FIG. 12C. The tolerable residual vibration is assumed to be 0.1 mm. As shown in FIG. 12A to 12C, there is greater residual vibration as the gradient at the beginning and the end of the envelope signal increases. In this example, in order to contain the residual vibration within a range of ±0.1 mm, the gradient at the beginning and the end of the envelope signal may be adjusted to within a range of ±33 mm/s. As the gradient at the beginning and the end of the envelope signal increases, the range in the central portion of the target vibration where the envelope signal lies flat increases, and therefore, as shown in FIG. 12A to 12C, the residual vibration at the central portion of the target vibration will decrease.

Thus, from independent vibrations at a plurality of vibration points, a driving signal for actually presenting a target tactile sensation to the user can be determined.

In the present embodiment, a residual vibration associated with the gradient at the beginning and the end of the envelope signal is estimated in order to adjust the gradient of the envelope signal. Alternatively, a relationship between the gradient at the beginning and the end of the envelope signal and the residual vibration may be previously retained, and a gradient for the envelope signal may be determined from this retained information. Alternatively, gradients for the envelope signal at which vibration residues would be tolerable may be previously retained for use.

Although the present embodiment adopts an envelope signal that has the largest gradient while the residual vibration is kept within a tolerable range, the gradient of the envelope signal does not need to be largest so long as the residual vibration is tolerable. However, as the gradient of the envelope signal becomes lower, the tactile sensation perceived by the user will become weaker.

Although the present embodiment illustrates a trapezoidal envelope signal as an example, the envelope signal may have a triangle shape which results after the flat portion of a trapezoid is eliminated. Since the appropriate envelope signal shape varies depending on the characteristics of members such as the vibration panel 1 and on the tactile sensation to be presented, it may be adapted to such members and the application.

Although the present embodiment illustrates that the envelope signal has a flat central portion, it may have an adjusted gradient so long as the residual vibration remains within a tolerable range. Moreover, the central portion of the envelope signal may have fluctuating residual vibration within a tolerable range.

Although the present embodiment illustrates exemplary numerical values for the target vibration and the tolerable residue, the present embodiment is not limited to such numerical values as are used, but is applicable to any arbitrary numerical values.

### Embodiment 3

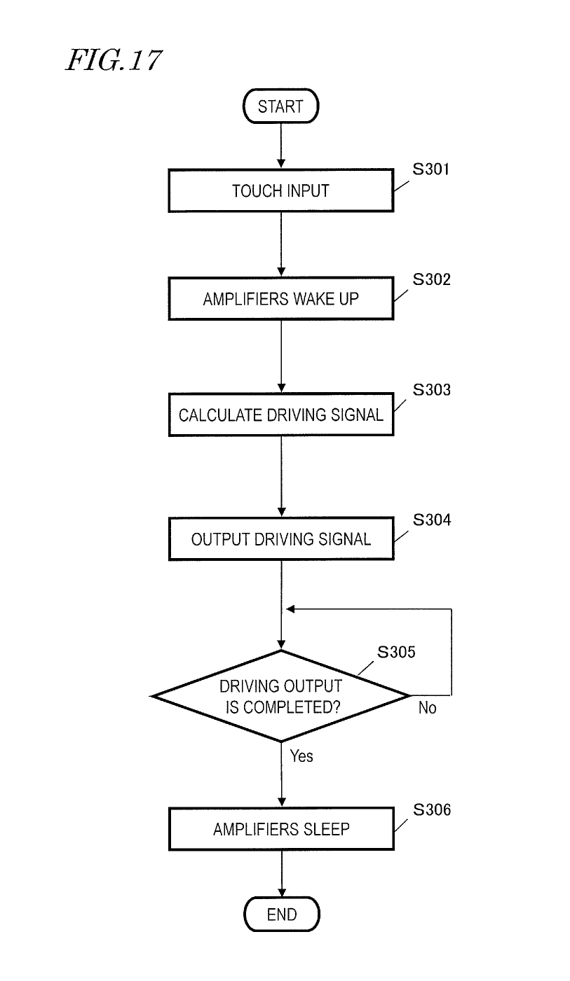

A tactile presentation apparatus 100 according to Embodiment 3 will be described with reference to FIG. 16 and FIG. 17. FIG. 16 is a diagram showing the construction of the tactile presentation apparatus 100 according to the present embodiment. FIG. 17 is a flowchart showing a procedure of vibration output.

As for FIG. 16, only differences from FIG. 1 will be described, while omitting any redundant description. A driving signal for the piezoelectric element 10 from the driving multiplication section 61 is amplified by the amplifier 80 and sent to the piezoelectric element 10. A driving signal for the piezoelectric element 11 from the driving multiplication section 61 is amplified by the amplifier 81 and sent to the piezoelectric element 11. In order to reduce power consumption, when amplification is unnecessary, e.g., there is zero driving of the piezoelectric elements, the amplifier 80 and amplifier 81 may be placed in sleep mode.

The method illustrated in Embodiment 1 reduces the amount of computation until driving signal generation, in order to shorten the response time. When the amplifier 80 and amplifier 81 resume from the sleep mode, some time is needed for the circuit to become stable. Therefore, if an instruction for allowing the amplifier 80 and amplifier 81 to resume from the sleep mode is sent immediately before beginning to output driving signals, correct transmission of the driving signals to the piezoelectric elements 10 and 11 will not occur until resume from the sleep mode is completed. If the beginning of driving signal output needs to wait until completion of resume from the sleep mode, there will be a long response time.

In order to generate vibration with a short response time from a touch operation, the tactile presentation apparatus 100 operates as shown in FIG. 17. At step S301, a touch input is detected, and at step S302, an instruction to wake up the amplifier 80 and amplifier 81 is sent. Thereafter, at step S303, a driving signal to be output from the driving multiplication section 61 is calculated, and at step S304, the driving signal begins to be output from the driving multiplication section 61 to the piezoelectric elements 10 and 11, via the amplifier 80 and amplifier 81. At step S305, completion of outputting of driving signals from the driving multiplication section 61 is waited. At step S306, the amplifier 80 and amplifier 81 are placed in sleep mode.

Thus, the response time can be shortened by sending an instruction to wake up the amplifier 80 and amplifier 81 before driving signal calculation, and calculating the driving signals by utilizing the time until the circuit becomes stable.

Although the present embodiment illustrates that the amplifier 80 and amplifier 81 are allowed to resume from the sleep mode before calculating the driving signals, they may resume from the sleep mode in the middle of driving signal calculation, so long as the circuit will become stable before the driving signals begin to be output.

### Embodiment 4

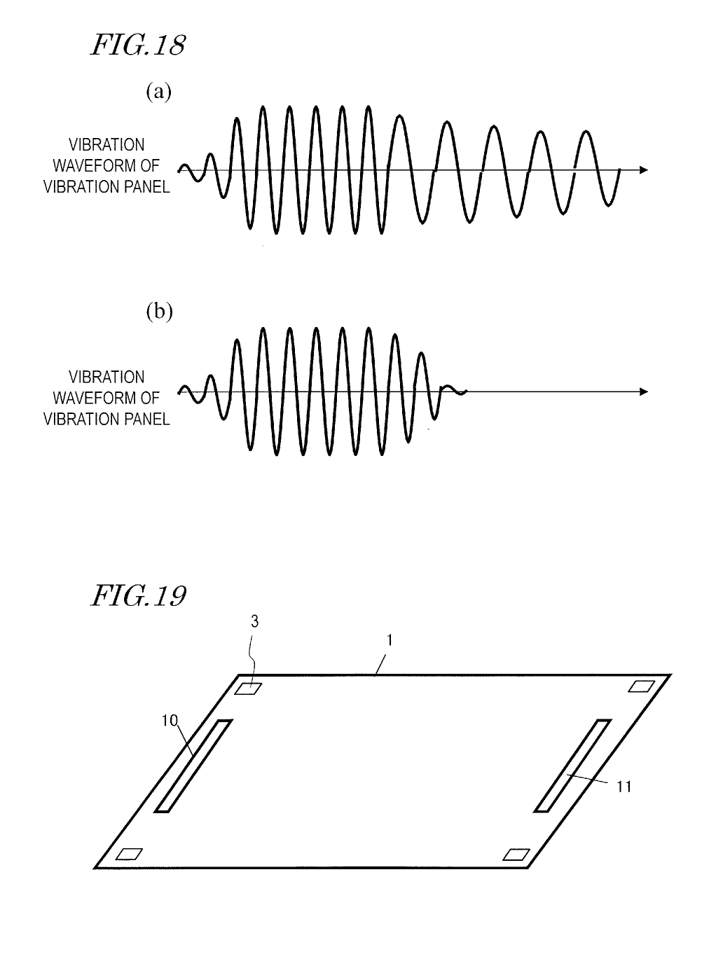

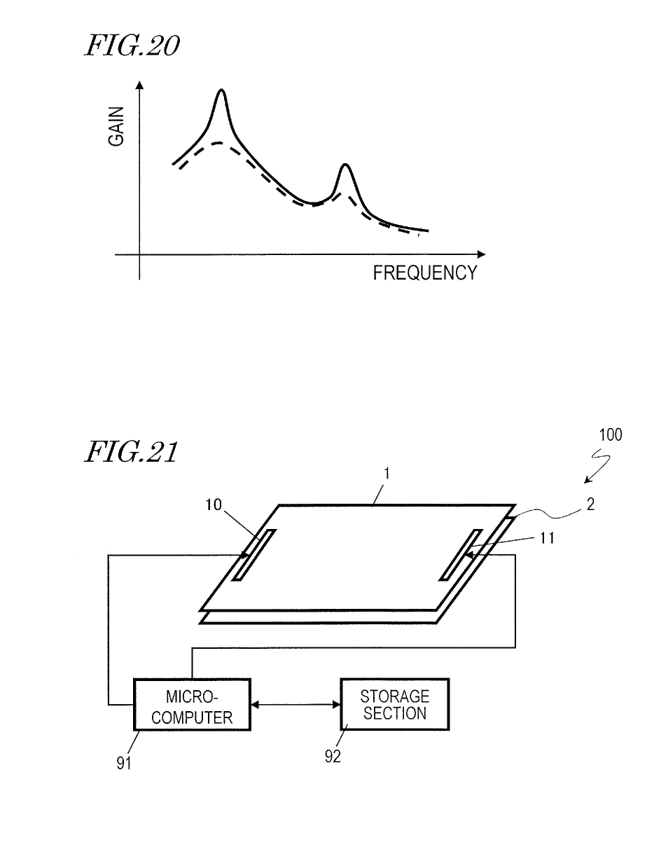

The tactile presentation apparatus 100 according to Embodiment 4 will be described with reference to FIG. 18 and FIG. 20. FIG. 18(a) shows an exemplary vibration waveform at a vibration point in the case where the vibration panel 1 has a strong resonance intensity. FIG. 18(b) shows an exemplary vibration waveform at a vibration point in the case where the vibration panel 1 has a weak resonance intensity. In FIG. 18, the horizontal axis represents time, and the vertical axis represents the respective signal level. FIG. 20 shows exemplary transfer characteristic profiles at a vibration point in the case of a strong resonance intensity and in the case of a weak resonance intensity. In FIG. 20, the solid line denotes the transfer characteristic profile under a strong resonance intensity, and the broken line denotes the transfer characteristic profile under a weak resonance intensity.

In the method illustrated in Embodiment 1, the amount of computation is reduced by limiting the frequency of the transfer characteristic profiles to only the carrier frequency. A mechanical structure, such as the vibration panel 1, has resonance, with its resonant frequency and resonance intensity being determined by its structure and material. If the resonance is too strong, vibration caused by the piezoelectric elements excites resonance of the vibration panel 1, which takes time to subside. If the resonance is weak as shown in FIG. 18(b), a target vibration can still be generated by driving the piezoelectric elements. However, if the resonance is strong as shown in FIG. 18(a), some resonance will be excited as the piezoelectric elements are driven, and the vibration of the resonant frequency will take time to subside at the end of vibration, thus resulting in vibrations not conforming to the target vibration.

When the carrier frequency and the resonant frequency of the vibration panel 1 are not equal, the method illustrated in Embodiment 1 may not be able to generate correct driving signals for the piezoelectric elements that suppress vibration at the resonant frequency, because only transfer characteristic profiles at the carrier frequency are utilized.

Since the resonant frequency and resonance intensity are determined by structure and material, buffer members 3 can be provided on the vibration panel 1 having transfer characteristics with a strong resonance as indicated by the solid line in FIG. 20, whereby the resonance intensity can be reduced as indicated by the broken line in FIG. 20. Note that the buffer members 3 may be adhesively bonded to the vibration panel 1, or held in contact with the vibration panel 1 by being sandwiched between the housing and the vibration panel 1. If the material composing the vibration panel 1 is eligible as the buffer members 3, the vibration panel 1 may be configured to possess protrusions serving as the buffer members. Note that the placement shown in FIG. 20 is only exemplary, and other placements may be possible so long as a buffering function is exhibited. FIG. 19 is a diagram showing a vibration panel 1 having buffer members 3 provided thereon. The buffer members 3 may be formed of silicone rubber or urethane, for example, but are not limited thereto.

Note that providing too many buffer members 3 makes it more difficult for the vibration panel 1 to vibrate, thus increasing the driving power for the piezoelectric elements that is needed to cause a target vibration. Therefore, the buffer members 3 may be provided to an extent that the amount of time until excited resonance of the vibration panel 1 subsides will fall within a range of e.g. 100 ms or less, and that the driving power for the piezoelectric elements will be at a tolerable level.

Thus, without greatly increasing the driving power for the piezoelectric elements, the influence of resonance of the vibration panel 1 is reduced to allow target vibrations to be generated.

Although the present embodiment illustrates use of the buffer members 3 to reduce the resonance intensity of the vibration panel 1, anything that absorbs vibration may be added to the vibration panel 1 instead. Resonance intensity may also be reduced by changing the material of the vibration panel 1.

In the above embodiments, each component element may be implemented as a dedicated piece of hardware, or implemented by executing a software program which is suitable for the respective component element. Each component element may be implemented by a program executing section, e.g., a CPU or a processor, that reads and executes a software program which is recorded on a storage medium such as a hard disk or a semiconductor memory, or an external server that is connected via a network. Although the respective component elements are described as being separate for convenience of explanation, it suffices so long as the entire flow is somehow executable: for example, it is not intended that the processes by the carrier generation section 60 and the driving multiplication section 61 are to be implemented in separate dedicated pieces of hardware.

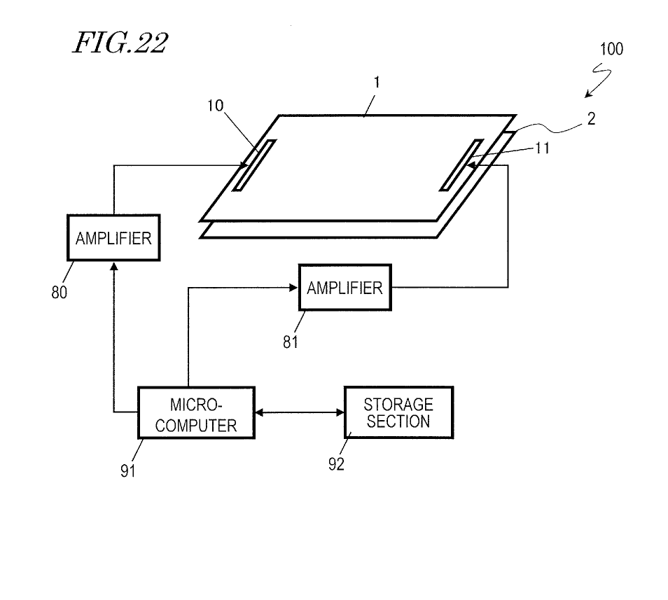

FIG. 21 is a diagram showing a tactile presentation apparatus 100 including a microcomputer 91 and a storage section 92. FIG. 22 shows a construction in which a tactile presentation apparatus 100 having amplifiers 80 and 81 includes a microcomputer 91 and a storage section 92. The storage section 92 may be a storage medium such as a hard disk or a semiconductor memory, for example. The microcomputer 91 reads a software program and various data recorded in the storage section 92, and executes the various processes described above. For example, the process which is performed by at least one of the transfer characteristics storage section 20, the vibration point determination section 30, the target vibration determination section 40, the transfer characteristics acquisition section 50, the carrier generation section 60, and the driving multiplication section 61 shown in FIG. 1 and FIG. 16, as well as the residual vibration estimation section 70 shown in FIG. 9, may be realized by a construction that combines the microcomputer 91 and the storage section 92.

Thus, as described above, the tactile presentation apparatus 100 according to an embodiment includes: a touch section 1 to present tactile sensations through contact with the user; a plurality of vibrating sections 10 and 11 to vibrate the touch section 1; a vibration point determination section 30 to determine a plurality of vibration points on the touch section 1; a target vibration determination section 40 to determine target vibrations at the determined plural vibration points; and driving signal generation sections 60 and 61 to generate driving signals for driving vibrating sections 10 and 11 based on vibration transfer characteristic profiles obtained according to the positions of the determined plural vibration points and main component frequencies of the determined target vibrations, and on the determined target vibrations. The driving signal generation sections 60 and 61 generate the driving signals based on the transfer characteristic profiles corresponding to near the main component frequencies of the determined target vibrations. Since this reduces the amount of computation for generating driving signals for the vibrating sections 10 and 11, response time can be reduced, and presentation of tactile sensations can be realized with little circuit and software resource.

The tactile presentation apparatus 100 may further include: a transfer characteristics storage section 20 to store a plurality of transfer characteristic profiles of vibration from the vibrating sections 10 and 11 to the touch section 1; and a transfer characteristics acquisition section 50 to acquire from the transfer characteristics storage section 20 transfer characteristic profiles for use in driving the vibrating sections 10 and 11, based on positions of the determined plural vibration points and on the main component frequency of the determined target vibrations. The transfer characteristics acquisition section 50 may acquire transfer characteristic profiles corresponding to near the main component frequencies of the determined target vibrations. Since this reduces the amount of computation for generating driving signals for the vibrating sections 10 and 11, response time can be reduced, and presentation of tactile sensations can be realized with little circuit and software resource.

The target vibration determination section 40 may, for example, increase and decrease an envelope signal in linear fashion at the beginning and the end of a target vibration. As a result, the influence of each target vibration at one vibration point can be reduced at another vibration point.

The target vibration determination section 40 may, for example, assign zero gradient to the envelope signal in a central portion, excluding the beginning and the end, of each target vibration. As a result, the influence of a target vibration at one vibration point can be reduced at another vibration point.

The transfer characteristics acquisition section 50 may, for example, acquire transfer characteristic profiles corresponding to main component frequencies of the target vibrations. As a result, the amount of computation required for generating driving signals for the vibrating sections 10 and 11 can be reduced.

The touch section 1 may, for example, accept a touch operation by a user and detect touched positions, and the vibration point determination section 30 may determine vibration points based on the detected touched positions. As a result, the vibrating position of the vibration panel can be made to rapidly follow a touch operation.

The transfer characteristics storage section 20 may, for example, store transfer characteristic profiles whose inputs are the driving signals for the vibrating section 10 or 11. By utilizing inverse transfer characteristics, driving signals for the vibrating sections 10 and 11 can be easily derived.

For example, a plurality of candidate points for vibration points may be allocated on the touch section 1, and the transfer characteristics storage section 20 may store transfer characteristic profiles whose outputs are the vibrations at the respective candidate points. As a result, a transfer characteristic profile that is optimum for the target vibration point can be selected.

The transfer characteristics acquisition section 50 may, for example, acquire transfer characteristic profiles corresponding to near the carrier frequency of the determined target vibrations. As a result, the amount of computation required for generating driving signals for the vibrating sections 10 and 11 can be reduced.

The driving signal generation sections 60 and 61 may, for example, calculate a driving gain and a carrier phase for the vibrating sections 10 and 11 based on the gain and phase of each transfer characteristic profile. As a result, the amount of computation required for generating driving signals for the vibrating sections 10 and 11 can be reduced.

The driving signal generation sections 60 and 61 may generate the driving signals for the plurality of vibrating sections 10 and 11 by, for example, multiplying an envelope signal of each determined target vibration by a carrier signal determined for each of the plurality of vibrating sections 10 and 11, the carrier signal having a driving gain and a carrier phase. As a result, the amount of computation required for generating driving signals for the vibrating sections 10 and 11 can be reduced.

The tactile presentation apparatus 100 may further include a residual vibration estimation section 70 to estimate a vibration at each vibration point based on the target vibration being output from the target vibration determination section 40 and on the transfer characteristic profile being output from the transfer characteristics storage section 20 and determine a residue of the target vibration, and the target vibration determination section 40 may adjust the gradient at the beginning and the end of the envelope signal of the target vibration based on the residue. As a result, the influence of a target vibration at one vibration point can be reduced at another vibration point.

The target vibration determination section 40 may adjust the gradient at the beginning and the end of the envelope signal of each target vibration so that, for example, the residue is equal to or less than a predetermined value. As a result, the influence of a target vibration at one vibration point can be reduced at another vibration point.

The target vibration determination section 40 may, for example, shape the waveform of the envelope signal in triangular form. As a result, the influence of a target vibration at one vibration point can be reduced at another vibration point.

The tactile presentation apparatus 100 may further include a residual vibration estimation section 70 to estimate a vibration at each vibration point based on the target vibration being output from the target vibration determination section 40 and on the transfer characteristic profile being output from the transfer characteristics storage section 20 and determine a residue of the target vibration, and the target vibration determination section 40 may adjust the gradient of the envelope signal in a central portion, excluding the beginning and the end, of the target vibration based on the residue. As a result, the influence of a target vibration at one vibration point can be reduced at another vibration point.

The tactile presentation apparatus 100 may further include buffer members 3 for decreasing the resonance intensity of the touch section 1. As a result, the end of a vibration at each vibration point can be kept closer to the target vibration.

The buffer members 3 may reduce the resonance intensity so that, for example, a vibration caused by excited resonance subsides within 100 ms. As a result, the end of a vibration at each vibration point can be kept closer to the target vibration.

The tactile presentation apparatus 100 may further include amplification sections 80 and 81 to amplify driving signals generated by the driving signal generation sections 60 and 61 and output the driving signals to the vibrating sections 10 and 11, and the amplification sections 80 and 81 may enter a sleep mode when not generating any vibration, and the amplification sections 80 and 81 may exit the sleep mode before the driving signal generation sections 60 and 61 finish calculating the driving signals. As a result, a delay in response time due to the amount of time required for waking up the amplification sections 80 and 81 can be reduced.

A tactile presentation method according to an embodiment includes: a step of determining a plurality of vibration points on a touch section 1 which comes in contact with the user; a step of determining target vibrations at the determined plural vibration points; a step of generating driving signals for driving vibrating sections 10 and 11 which vibrate the touch section 1, based on vibration transfer characteristic profiles obtained according to the positions of the determined plural vibration points and the main component frequencies of the determined target vibrations, and on the determined target vibrations; and a step of vibrating the touch section 1 to present a tactile sensation to the user. The step of generating driving signals generates the driving signals based on the transfer characteristic profiles corresponding to near the main component frequencies of the determined target vibrations. Since this reduces the amount of computation for generating driving signals for the vibrating sections 10 and 11, response time can be reduced, and presentation of tactile sensations can be realized with little circuit and software resource.

A computer program according to an embodiment is a computer program for causing a tactile presentation apparatus 100 to execute a vibration operation, the computer program causing a computer in the tactile presentation apparatus 100 to execute: a step of determining a plurality of vibration points on a touch section 1 which comes in contact with the user; a step of determining target vibrations at the determined plural vibration points; a step of generating driving signals for driving vibrating sections 10 and 11 which vibrate the touch section 1, based on vibration transfer characteristic profiles obtained according to the positions of the determined plural vibration points and the main component frequencies of the determined target vibrations, and on the determined target vibrations; and a step of vibrating the touch section 1 to present a tactile sensation to the user. The step of generating driving signals generates the driving signals based on the transfer characteristic profiles corresponding to near the main component frequencies of the determined target vibrations. Since this reduces the amount of computation for generating driving signals for the vibrating sections 10 and 11, response time can be reduced, and presentation of tactile sensations can be realized with little circuit and software resource.

The tactile presentation apparatus and tactile presentation method according to the present disclosure are capable of presenting different tactile sensations in response to multiple touches, and therefore are applicable to the user interface of a television set, a digital still camera, a digital camcorder, a personal computer, a personal digital assistant, a mobile phone, or the like, for example. Moreover, it is also applicable to devices where a number of people will be simultaneously touching on a screen, e.g., an electronic blackboard, a display for digital signage, for example. It is also applicable to various electronic devices to be installed in an automobile, e.g., a touch pad, a car navigation system, a car audio system, or an air conditioner, for example.

While the present invention has been described with respect to exemplary embodiments thereof, it will be apparent to those skilled in the art that the disclosed invention may be modified in numerous ways and may assume many embodiments other than those specifically described above. Accordingly, it is intended by the appended claims to cover all modifications of the invention that fall within the true spirit and scope of the invention.

This application is based on Japanese Patent Applications No. 2013-131812 filed on Jun. 24, 2013 and No. 2014-124275 filed on Jun. 17, 2014, the entire contents of which are hereby incorporated by reference.

What is claimed is:

1. An apparatus comprising:
a touch section configured to receive a touch made by a user;
a plurality of vibrating sections configured to cause vibration in the touch section;
a first determination section configured to determine a plurality of vibration points on the touch section;
a second determination section configured to determine a plurality of target vibrations, respectively, at the plurality of vibration points; and
a signal generation section configured to generate a plurality of driving signals for respectively driving the plurality of vibrating sections, based on vibration transfer characteristic profiles obtained according to positions of the plurality of vibration points and main component frequencies of the plurality of target vibrations, and on the plurality of target vibrations, wherein,
the signal generation section generates the plurality of driving signals based on a plurality of transfer characteristic profiles respectively corresponding to the plurality of target vibrations near the main component frequencies.

2. The apparatus of claim 1, further comprising:
a storage section configured to store a plurality of transfer characteristic profiles of vibration from the respective vibrating sections to the touch section; and
an acquisition section configured to acquire from the storage section transfer characteristic profiles for use in driving the plurality of vibrating sections, based on positions of the plurality of vibration points and on the main component frequencies of the plurality of target vibrations, wherein,
as each transfer characteristic profile, the acquisition section acquires a gain and a phase near the main component frequency of each target vibration.

3. The apparatus of claim 1, wherein the second determination section determines each target vibration by using an envelope signal which substantially linearly increases and decreases, respectively, at a beginning and an end thereof.

4. The apparatus of claim 1, wherein the second determination section determines each target vibration by using an envelope signal having a gradient which is near zero in a central portion, the central portion excluding a beginning and an end of the envelope signal.

5. The apparatus of claim 1, wherein the second determination section determines each target vibration by using an envelope signal having a substantially triangular waveform.

6. The apparatus of claim 1, wherein,
the touch section accepts a touch operation by a user and detects a plurality of touched positions; and
the first determination section determines the plurality of vibration points based on the detected plural touched positions.

7. The apparatus of claim 1, wherein,
a plurality of candidate points for vibration points are allocated on the touch section; and
each of the plurality of transfer characteristic profiles is a transfer characteristic profile an input of which is a respective one of the plurality of driving signals for the plurality of vibrating sections, and an output of which is a vibration at a respective one of the candidate points.

8. The apparatus of claim 2, wherein the signal generation section calculates a driving gain and a carrier phase for each vibrating section based on the gain and phase of each transfer characteristic profile.

9. The apparatus of claim 8, wherein the signal generation section generates the driving signals for the plurality of vibrating sections by multiplying an envelope signal of each target vibration by a carrier signal determined for each of the plurality of vibrating sections, the carrier signal having a driving gain and a carrier phase.

10. The apparatus of claim 3, further comprising a residue estimation section configured to estimate a vibration at each vibration point based on the target vibration and the transfer characteristic profile and determine a residue of the target vibration, wherein
the second determination section updates the target vibration by using an envelope signal which is adjusted based on the residue.

11. The apparatus of claim 9, wherein the second determination section adjusts a gradient at a beginning and an end of the envelope signal of each target vibration so that the residue is equal to or less than a predetermined value.

12. The apparatus of claim 9, wherein the second determination section adjusts a gradient in a central portion excluding a beginning and an end of the envelope signal of each target vibration so that the residue is equal to or less than a predetermined value.

13. The apparatus of claim 1 further comprising a buffer member provided on the touch section.

14. The apparatus of claim 13, wherein, in the touch section having the buffer member provided thereon, a vibration caused by excited resonance subsides within 100 ms.

15. The apparatus of claim 1, further comprising:
an amplification section configured to amplify the driving signal and output the driving signal to the vibrating section, wherein
the amplification section enters a sleep mode when not generating any vibration in the touch section, and exits the sleep mode before the signal generation section finishes calculating the driving signal.

16. A method comprising:
a step of determining a plurality of vibration points in a touch section to receive a touch made by a user;
a step of determining a plurality of target vibrations, respectively, at the plurality of vibration points; and
a step of generating a plurality of driving signals for respectively driving a plurality of vibrating sections to cause vibration in the touch section, based on vibration transfer characteristic profiles obtained according to positions of the plurality of vibration points and main component frequencies of the plurality of target vibrations, and on the plurality of target vibrations, wherein,
the step of generating the plurality of driving signals generates the plurality of driving signals based on a plurality of transfer characteristic profiles respectively corresponding to the plurality of target vibrations near the main component frequencies.

17. An apparatus comprising: a touch section configured to receive a touch made by a user; a plurality of vibrating sections configured to cause vibration in the touch section; a storage section; and one or more processors connected to the storage section,
the one or more processors executing:
a first determination step of determining a plurality of vibration points on the touch section;
a second determination step of determining a plurality of target vibrations, respectively, at the plurality of vibration points; and
a signal generation step of generating a plurality of driving signals for respectively driving the plurality of vibrating sections, based on vibration transfer characteristic profiles obtained according to positions of the plurality of vibration points and main component frequencies of the plurality of target vibrations, and on the plurality of target vibrations, wherein,
the signal generation step generates the plurality of driving signals based on a plurality of transfer characteristic profiles respectively corresponding to the plurality of target vibrations near the main component frequencies.
